(19) United States
(12) Patent Application Publication
(10) Pub. No.: US 2025/0180452 A1
(43) Pub. Date: Jun. 5, 2025

(54) CRACK GROWTH PREDICTION DEVICE, CRACK INSPECTION SYSTEM, AND CRACK GROWTH PREDICTION METHOD

(71) Applicant: Mitsubishi Electric Corporation, Tokyo (JP)

(72) Inventors: Norihiko HANA, Tokyo (JP); Masaki UMEDA, Tokyo (JP); Kenji AMAYA, Tokyo (JP); Rinya HATANAKA, Tokyo (JP)

(73) Assignee: Mitsubishi Electric Corporation, Tokyo (JP)

(21) Appl. No.: 18/844,994

(22) PCT Filed: Mar. 14, 2022
(86) PCT No.: PCT/JP2022/011234

§ 371 Date: Sep. 9, 2024

(51) Int. Cl. G01N 3/08

(52) U.S. Cl. CPC G01N 3/08; G01N 2203/0064; G01N 2203/0066; G01N 2203/0218

(57) ABSTRACT

A crack growth prediction device includes: a parameter input unit to which parameters of initial values of at least a shape of the structure, a force applied to the structure, a material characteristic of the structure, and a crack shape, including uncertainty of each parameter, are each inputted as a probability distribution; a model generation unit which generates a state space model for predicting a crack growth state constituted of a state equation and an observation equation from the inputted parameters; a crack shape measurement unit which measures the crack shape of the structure; and an estimation unit which estimates a posterior distribution including the crack shape and the parameters, from a probability distribution of a measurement value of the crack shape measured by the crack shape measurement unit and uncertainty due to measurement error, and a prior distribution of the crack shape predicted by the state space model.

### TECHNICAL FIELD

The present disclosure relates to a crack growth prediction device, a crack inspection system, and a crack growth prediction method.

### BACKGROUND ART

In conventional structure crack inspection, when the growth amount of a found crack is predicted, the crack growth characteristic includes uncertainty depending on the measured crack shape, the inspection target shape, a force, displacement, or temperature applied to the inspection target, a material used in the inspection target, and the like. The growth amount of the crack estimated from uncertain information is also uncertain. The remaining life of the inspection target is estimated from the predicted growth amount of the crack with the uncertainty made as small as possible (see, for example, Patent Document 1).

### CITATION LIST

### Patent Document

Patent Document 1: Japanese Laid-Open Patent Publication No. 2009-31124

### SUMMARY OF THE INVENTION

### Problem to be Solved by the Invention

However, while the uncertainty of the estimated growth amount of the crack is reduced, the uncertainty cannot be quantitatively indicated. Thus, there is a problem that accuracy of the remaining life estimated from the growth amount of the crack cannot be quantitatively indicated.

The present disclosure has been made to solve the above problem, and an object of the present disclosure is to provide a crack growth prediction device, a crack inspection system, and a crack growth prediction method that can estimate the shape of a crack with the uncertainty of a measured crack shape reduced, and can quantitatively indicate the uncertainty of the growth amount of the crack by a probability distribution.

### Means to Solve the Problem

A crack growth prediction device according to the present disclosure is for predicting growth of a crack occurring in a structure and includes: a parameter input unit to which parameters of initial values of at least a shape of the structure, a force applied to the structure, a material characteristic of the structure, and a crack shape, including uncertainty of each parameter, are each inputted as a probability distribution; a model generation unit which generates a state space model for predicting a crack growth state constituted of a state equation and an observation equation from the inputted parameters; a crack shape measurement unit which measures the crack shape of the structure; and an estimation unit which estimates a posterior distribution including the crack shape and the parameters, from a probability distribution of a measurement value of the crack shape measured by the crack shape measurement unit and uncertainty due to measurement error, and a prior distribution of the crack shape predicted by the state space model. Growth of the crack is predicted from the crack shape and the parameters updated by the estimation unit.

### Effect of the Invention

The crack growth prediction device according to the present disclosure can estimate the shape of a crack with the uncertainty of a measured crack shape reduced, and can quantitatively indicate the uncertainty of the growth amount of the crack by a probability distribution.

### BRIEF DESCRIPTION OF THE DRAWINGS

FIG. 1 is a function configuration diagram of a crack growth prediction device according to embodiment 1.

FIG. 2 is a prediction flowchart in the crack growth prediction device according to embodiment 1.

FIG. 3 illustrates parameters of a structure for which growth of a crack is to be predicted.

FIG. 4 shows a probability distribution of parameters illustrated in FIG. 3.

FIG. 5 illustrates an example of a model for predicting growth of a crack according to embodiment 1.

FIG. 6 illustrates measurement of the shape of a crack in a structure according to embodiment 1.

FIG. 7 is a flowchart of estimation for a crack shape and parameters according to embodiment 1.

FIG. 8 is a function configuration diagram of a crack growth prediction device according to embodiment 2.

FIG. 9 is a prediction flowchart in the crack growth prediction device according to embodiment 2.

FIG. 10 is a flowchart showing operation of a crack inspection system including the crack growth prediction device according to embodiment 2.

FIG. 11 is a function configuration diagram of a crack growth prediction device according to embodiment 3.

FIG. 12 is a prediction flowchart in the crack growth prediction device according to embodiment 3.

FIG. 13 illustrates an example of prediction by an operation condition prediction unit according to embodiment 3.

FIG. 14 is a flowchart showing operation of a crack inspection system including the crack growth prediction device according to embodiment 3.

FIG. 15 is a prediction flowchart in a crack growth prediction device according to embodiment 4.

FIG. 16 illustrates an example of a hardware configuration of the crack growth prediction device according to each embodiment.

FIG. 17 illustrates another example of a hardware configuration of the crack growth prediction device according to each embodiment.

### DESCRIPTION OF EMBODIMENTS

Hereinafter, preferred embodiments of a crack growth prediction device, a crack inspection system, and a crack growth prediction method according to the present disclosure will be described with reference to the drawings. The same or corresponding elements are denoted by the same reference characters, and the detailed description thereof is omitted. Also in the subsequent embodiments, elements denoted by the same reference characters will not be repeatedly described.

### Embodiment 1

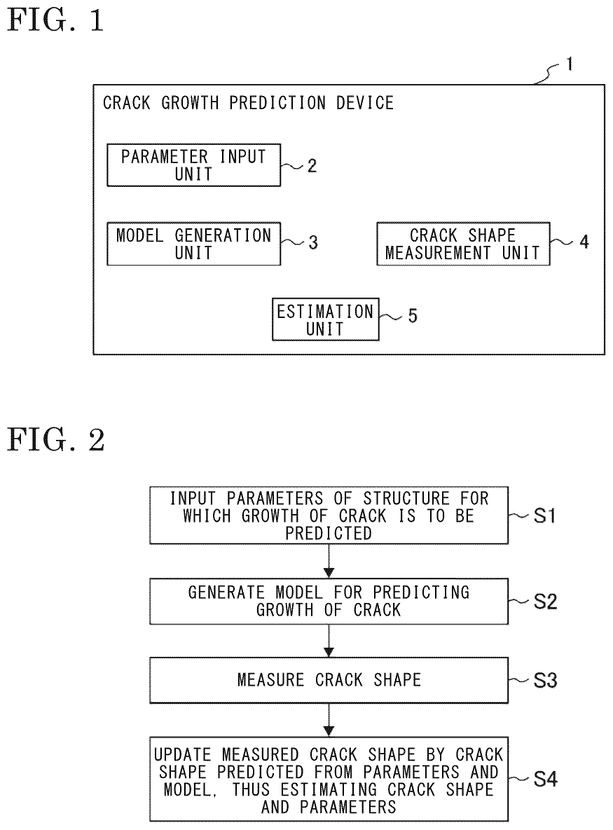

FIG. 1 shows a function configuration diagram of a crack growth prediction device according to embodiment 1 of the present disclosure. FIG. 2 shows a prediction flowchart according to embodiment 1 of the present disclosure.

As shown in FIG. 1, a crack growth prediction device 1 includes functions of a parameter input unit 2, a model generation unit 3, a crack shape measurement unit 4, and an estimation unit 5.

Operation in which the crack growth prediction device 1 shown in FIG. 1 predicts growth of a crack will be described with reference to the prediction flowchart in FIG. 2. First, parameters of a structure for which growth of a crack is to be predicted are inputted to the parameter input unit 2 (step S1). The model generation unit 3 generates a model for predicting growth of the crack (step S2). The crack shape measurement unit 4 measures the shape of the crack (step S3). The estimation unit 5 updates the shape of the crack measured by the crack shape measurement unit 4, using the crack shape predicted from the inputted parameters and the generated model, thus estimating the crack shape and the parameters (step S4).

Step S1 to step S4 will be described in more detail.

### (1) Step S1 (Operation of Parameter Input Unit 2)

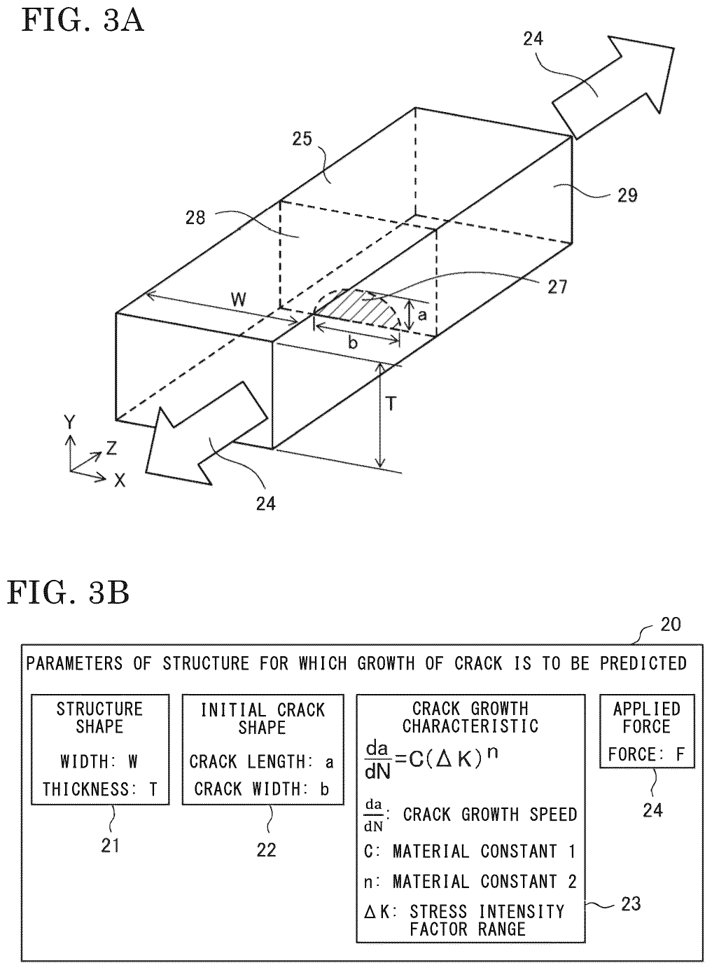

Regarding a structure shown in FIG. 3(a), examples of parameters for predicting growth of a crack, which are inputted to the parameter input unit 2, are shown in FIG. 3(b).

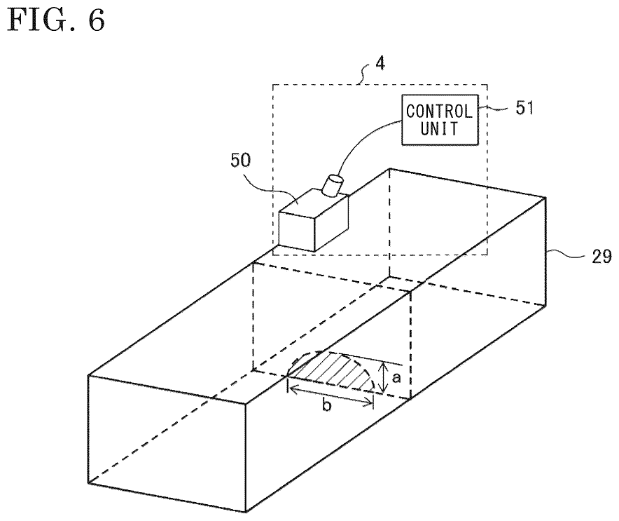

As an example, it is assumed that a crack 27 is present on a cross-section 28 which is an X-Y plane inside a structure 29 shown in FIG. 3(a) and a repetitive force 24 is applied. Crack inspection is performed from a surface 25 as shown in FIG. 6 described later, and an area around the cross-section 28 where the crack is present is inspected. As shown in FIG. 3(b), parameters 20 of the structure for which growth of the crack is to be predicted relate to elements such as a structure shape 21, an initial crack shape 22, a crack growth characteristic 23, and an applied force (which may be represented by burden, load, displacement, etc.) 24. Further, a temperature change may be inputted as an environmental change occurring on the structure.

As the parameters of the structure, the structure shape 21 is represented by a width W and a thickness T of the structure. The initial crack shape 22 is represented by a crack length a and a crack width b. The crack growth characteristic 23 is represented by the following Formula A. The applied force 24 is referred to as force F. The Formula A is represented as a relationship between a crack growth speed da/dN and a stress intensity factor range AK. In the Formula A, C and n are material constants.

$$[ Mathematical 1 ]$$

$$\frac{da}{dN} = {C ( Δ K )}^{n} \qquad Formula A$$

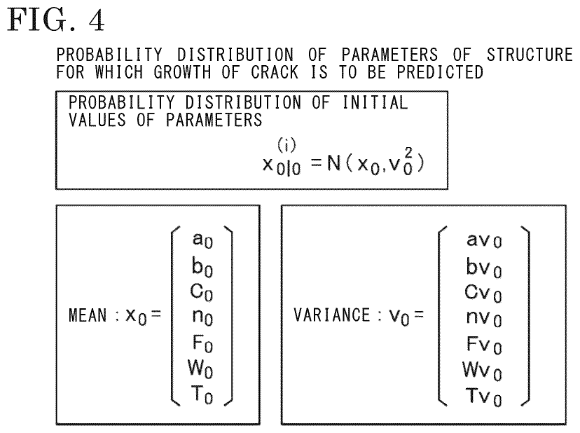

Each of the parameters shown in FIG. 3(b) has uncertainty. FIG. 4 shows an example in which parameters are represented by a probability distribution, including uncertainty. That is, parameters x shown in FIG. 3 are represented by a vector, and a probability distribution of the parameters is represented as a normal distribution N (x₀, v₀²). Then, a mean x₀ and a variance v₀ are inputted as initial values. In FIG. 4, (i) denotes a number of an ensemble member, and 0|0 denotes initial values of “time of predicted data | data time used in prediction”.

### (2) Step S2 (Operation of Model Generation Unit 3)

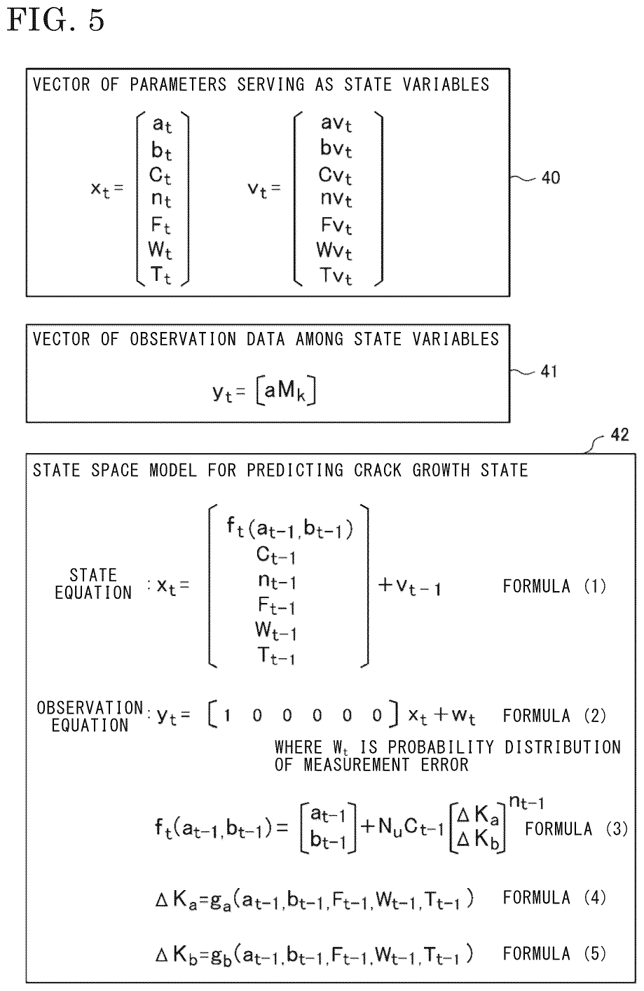

FIG. 5 shows an example of a model for predicting growth of the crack. A vector 40 of the parameters of the structure serving as state variables is defined by a vector xₜ of means and a vector vₜ of variances. Next, among the state variables, an observation vector yₜ of the crack length a is defined by a vector 41. In the vector 41, aMₖ denotes a crack length including measurement error. The vector 41 is a likelihood distribution of a measurement value of the crack shape and uncertainty due to measurement error. From the defined vector 40 of the parameters of the structure serving as state variables and the defined vector 41 of observation data of the crack length a, a state space model 42 for predicting the growth state of the crack is generated.

In the state space model 42, a state equation representing the relationship between the state vector xₜ at present and state vectors xₜ₋₁, vₜ₋₁ preceding by a certain period is shown by Formula (1). The state vector xₜ is represented by the parameters. The vector yₜ of the observation data is represented by the state vector xₜ and a vector wₜ of a probability distribution of measurement error, as shown by Formula (2) which is an observation equation. The observation data is a likelihood distribution constituted of a state vector and a probability distribution of measurement error. In Formula (1), fₜ which is a function of a crack length aₜ₋₁ and a crack width bₜ₋₁ has relationships shown by Formula (3), Formula (4), and Formula (5) representing the growth characteristic of the crack. Here, Nᵤ denotes a cycle, and stress intensity factor ranges ΔKₐ and ΔK_{b} are represented by functions gₐ and g_{b}.

### (3) Step S3 (Operation of Crack Shape Measurement Unit 4)

FIG. 6 shows an example in which measurement of the crack shape is actually performed. An ultrasonic flaw detection device 50 scans the structure 29, to measure the crack length a and the crack width b. The ultrasonic flaw detection device 50 is controlled by a control unit 51, to perform measurement. The measured crack length a and the crack width b are assumed as the observation vector y shown by the vector 41 in FIG. 5. Using ultrasonic flaw detection for crack inspection makes it possible to non-destructively inspect a crack at a part that cannot be seen, whereby the remaining life of the structure can be accurately estimated through inspection. Measurement of the crack shape does not necessarily need to be performed after operation of the model generation unit, and may be performed before model generation operation or at the same time as model generation.

### (4) Step S4 (Operation of Estimation Unit 5)

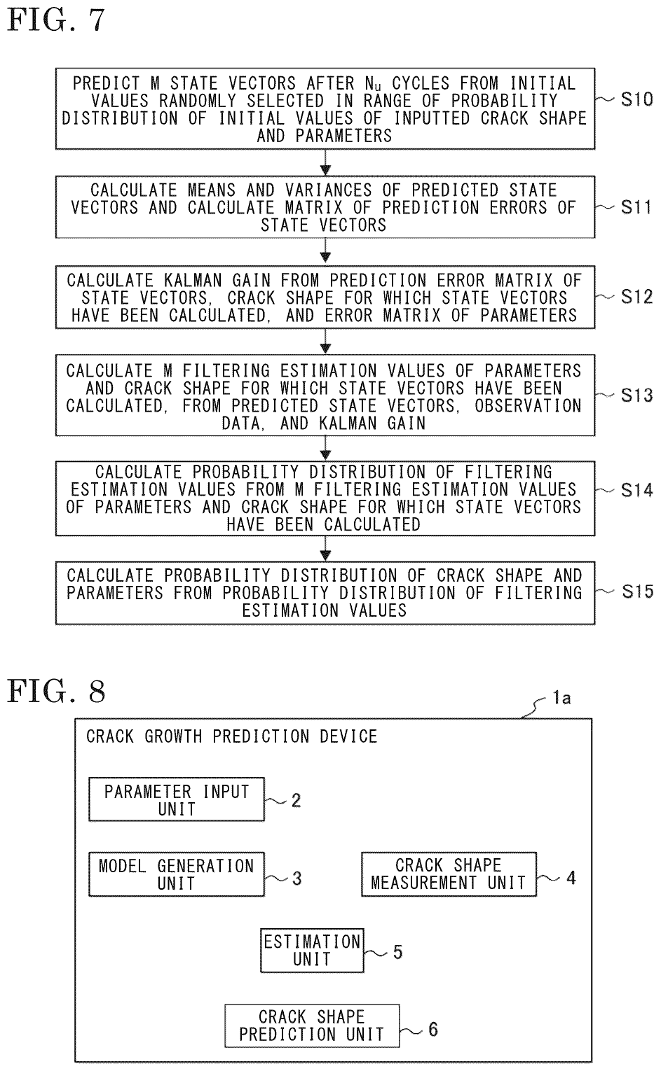

FIG. 7 shows a flow in which the crack shape measured by the crack shape measurement unit 4 is updated by a crack shape predicted using the state space model 42, thus estimating the crack shape and the parameters. For estimation of the crack shape and the parameters, an ensemble Kalman filter is used. In a Kalman filter, it is necessary to linearly approximate a phenomenon to be estimated, but in the ensemble Kalman filter, a nonlinear crack growth phenomenon can be directly estimated. Thus, crack prediction accuracy is improved.

In FIG. 7, first, M state vectors after Nᵤ cycles are predicted from initial values randomly selected in the range of the probability distribution of initial values of the crack shape and the parameters that are inputted (step S10). Means and variances of the predicted M state vectors are calculated and a matrix of prediction errors of the state vectors is calculated (step S11). The predicted state vectors are defined as a prior distribution. A Kalman gain is calculated from the prediction error matrix of the state vectors, the crack shape for which the state vectors have been calculated, and an error matrix of the parameters (step S12).

Next, M filtering estimation values of the parameters and the crack shape for which the state vectors have been calculated are calculated from the predicted state vectors (prior distribution), the observation data (likelihood distribution), and the Kalman gain (step S13). A probability distribution of filtering estimation values is calculated from the M filtering estimation values of the parameters and the crack shape for which the state vectors have been calculated (step S14). A probability distribution of the crack shape and the parameters is calculated from the probability distribution of filtering estimation values (step S15) (inference of posterior distribution).

On the basis of the obtained probability distribution of the crack shape and the parameters, in a case where the probability distribution is a normal distribution, mean values are used as an estimation result for the crack shape and the parameters, and variances indicate dispersions in the estimation result for the crack shape and the parameters.

As described above, in the present embodiment, it is possible to estimate the shape of a crack with the uncertainty of a measured crack shape reduced, and quantitatively indicate the uncertainty of the growth amount of the crack by a probability distribution. In addition, estimation values and dispersions thereof for not only the crack but also parameters related to growth of the crack in a target structure are obtained, whereby a change other than a crack occurring in the structure can also be recognized and whether or not inspection for a part other than a crack part is needed can be judged. Thus, it becomes possible to take appropriate measures also for a change other than a crack and perform economical maintenance.

### Embodiment 2

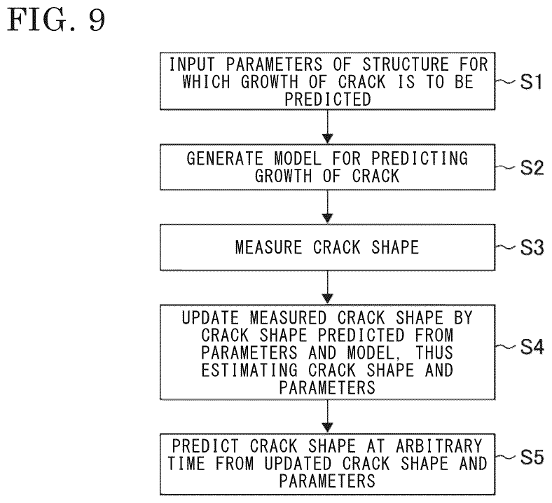

FIG. 8 shows a function configuration diagram of a crack growth prediction device 1a according to embodiment 2, and FIG. 9 shows a prediction flowchart. Only differences from embodiment 1 will be described, while the other matters are the same as in embodiment 1 and the description thereof is omitted. As shown in FIG. 8, the crack growth prediction device 1a includes a crack shape prediction unit 6 in addition to the configuration in embodiment 1. Owing to the addition of this component, as shown in FIG. 9, it becomes possible to predict a crack shape at any (arbitrary) time from the crack shape and the parameters updated by the estimation unit 5 (step S5).

Operation in step S5 will be described. As in step S10 in FIG. 7, the predicted state vectors are predicted values for the crack shape at an arbitrary time. Specifically, the number of cycles in which load application or displacement is repeated in a structure having a crack until the arbitrary time, is set, and M state vectors after the set number of cycles are calculated, using the crack shape and the parameters estimated in step S4, as initial values. By assuming a probability distribution of the M state vectors, predicted values and dispersions are calculated. In a case where the probability distribution is a normal distribution, the predicted values are mean values, and dispersions are variances. By calculating predicted values and dispersions for the growth amount of a crack, a timing for repair or replacement of an inspection target can be quantitatively judged and efficient maintenance can be performed.

As described above, the crack shape prediction unit 6 predicts a probability distribution of a crack shape at an arbitrary time after measurement, from the crack shape obtained by the estimation unit 5. Then, the uncertainty of the growth amount of the crack is quantitatively indicated by a probability distribution on the basis of the crack shape with the uncertainty of the measured crack shape reduced, whereby a timing for repair or replacement of an inspection target can be quantitatively judged and efficient maintenance can be performed.

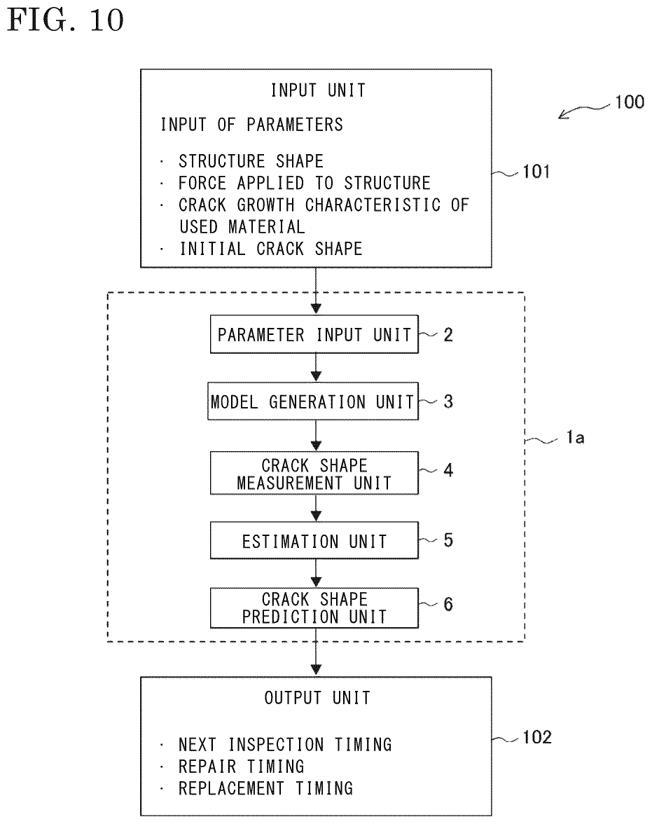

FIG. 10 is a flowchart showing operation of a crack inspection system 100 including the crack growth prediction device 1a described in embodiment 2. In the crack inspection system 100, the shape of the structure 29, a force or displacement applied to the structure 29, the crack growth characteristic of a used material, an initial crack shape, and the like, are inputted as parameters, by an input unit 101. Examples of input means include direct input of data by a keyboard or a mouse, input of data transferred from a memory device, reception of data transmitted wirelessly or via a wire from another device, and reception of data transmitted from the Internet, a cloud, or the like, but the input means is not limited thereto.

With the parameters inputted, the crack growth prediction device 1a performs operation as described above, i.e., the parameter input unit 2 calculates a probability distribution of each parameter, and the model generation unit 3 generates the state space model 42 for predicting the growth state of a crack. In addition, the crack shape measurement unit 4 measures the crack shape, and the estimation unit 5 updates the measured crack shape by the crack shape predicted using the state space model. 42, thus estimating the crack shape and the parameters. From the crack shape obtained by the estimation unit 5, the crack shape prediction unit 6 predicts a probability distribution of the crack shape at an arbitrary time after measurement. On the basis of the predicted probability distribution, maintenance-related information such as data about a next inspection timing, a repair timing, and a replacement timing, is outputted from an output unit 102, with other factors taken into consideration. The other factors include a factor related to the structure itself and factors such as a schedule of an inspector, cost for inspection and repair, and an inventory of repair components. The information about the other factors may be inputted from the input unit 101.

The output unit 102 may include a determination unit for determining such timings. As a method for the determination unit to determine an inspection timing, a repair timing, or a replacement timing, the following method may be employed: a stress intensity factor of a crack shape at a next inspection timing, a repair timing, or a replacement timing after measurement, is calculated, a fracture toughness value of a rotor component is compared, and the above timing is determined on the basis of whether or not the fracture toughness value is equal to or smaller than a predetermined safety factor. The output unit 102 may include a display unit, and the predicted probability distribution, the next inspection timing, the repair timing, and the replacement timing may be displayed on the display unit. In addition, an alarm device such as a buzzer may be provided for notification of the replacement timing, the inspection timing, and the like. Further, the output unit may include communication means, and may transmit a determination result, relevant data, and prediction data to another device wirelessly or via a wire. Further, through connection to a network, the above data may be accumulated in a cloud or the like, to collect data of many components, and the collected data may be utilized for not only maintenance but also production, sale, and the like.

Next, a specific example in which a component of a rotor of an electric generator is inspected will be described. As parameters of the shape of a structure, there are a diameter/inner diameter of a rotor component, a dimension error thereof, and the like. As parameters of a force or displacement applied to a structure, there are a temperature change, a centrifugal force repeatedly occurring during rotation of a rotor and in a stopped state thereof, a centrifugal force due to change in the rotation speed in the rotor, and the like. As parameters of material characteristics of the rotor, there are characteristics of crack growth used in rotor components. Each of the above parameters has uncertainty.

The crack shape and uncertainty measured by the crack shape measurement unit 4 are a measurement value and a measurement error assumed for each measurement method. An initial crack shape and initial uncertainty to be provisionally given can be arbitrarily determined, but a crack shape and uncertainty according to the measurement method may be used.

As described above, with the crack inspection system 100 including the crack growth prediction device 1a, uncertainty of the growth amount of a crack is quantitatively indicated by a probability distribution, whereby a next inspection timing or a repair or replacement timing for a structure can be quantitatively judged and thus efficient maintenance can be performed.

### Embodiment 3

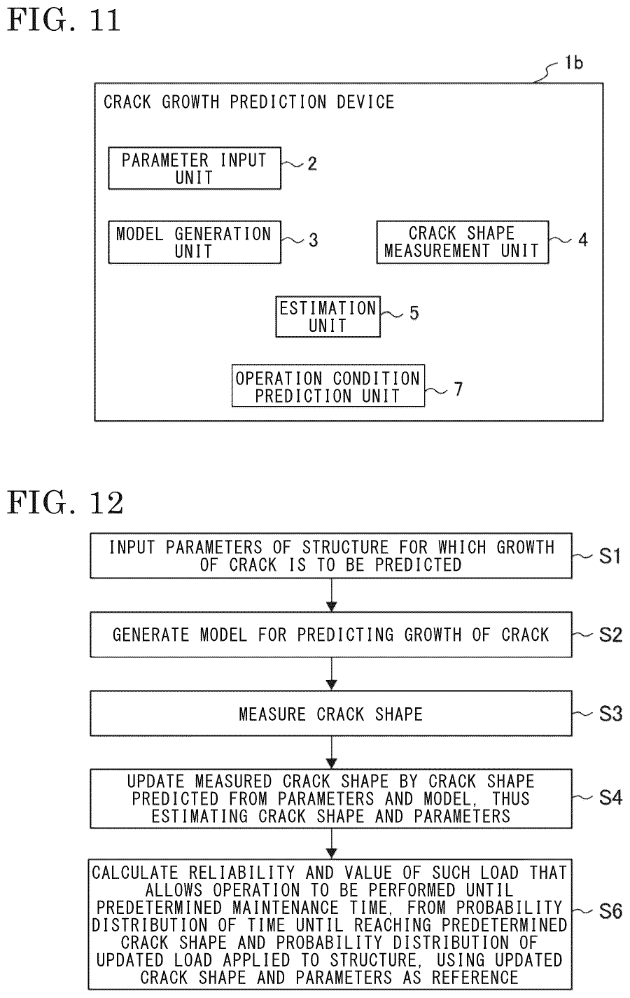

FIG. 11 shows a function configuration diagram of a crack growth prediction device 1b according to embodiment 3, and FIG. 12 shows a prediction flowchart. Only differences from embodiment 1 will be described, while the other matters are the same as in embodiment 1 and the description thereof is omitted. As shown in FIG. 11, the crack growth prediction device 1b includes an operation condition prediction unit 7 in addition to the configuration in embodiment 1. In the operation condition prediction unit 7, as shown in the flowchart in FIG. 12, reliability and the value of such a load that allows operation to be performed until a predetermined maintenance time are calculated from a probability distribution of a time until reaching a predetermined (prescribed) crack shape and a probability distribution of an updated load applied to the structure, using the crack shape and the parameters updated by the estimation unit 5 as a reference (step S6).

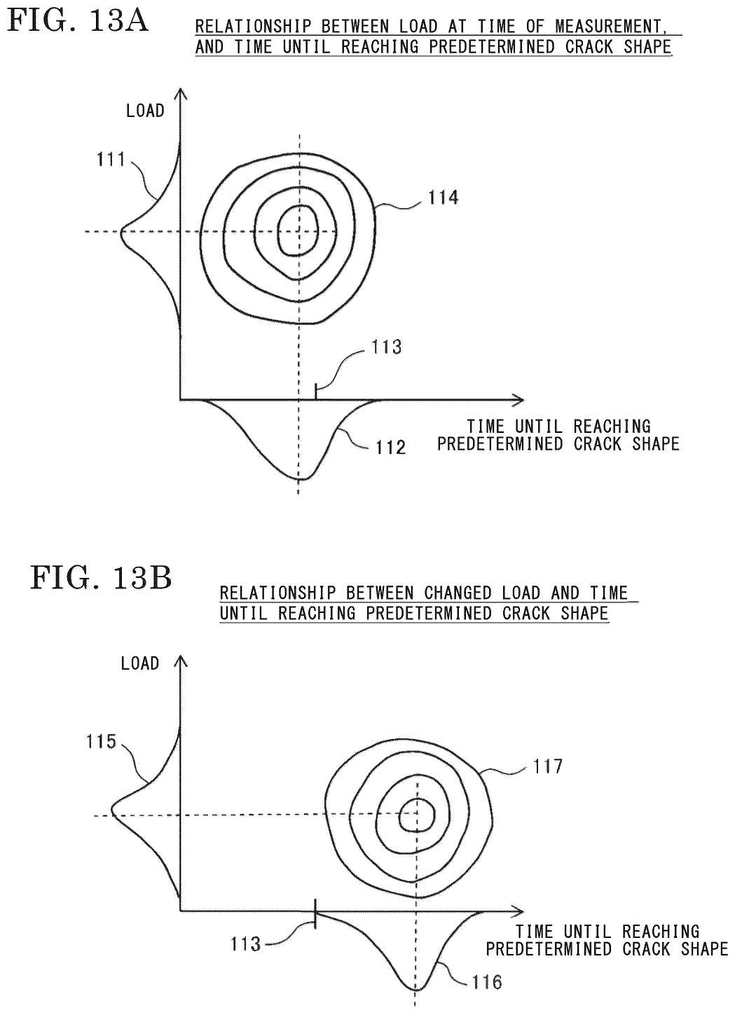

An example of prediction by the operation condition prediction unit 7 shown in step S6 will be described with reference to FIG. 13. FIG. 13(a) shows the relationship between a force (load) applied to the structure 29 at the time of measurement, and a time until reaching the predetermined crack shape, and FIG. 13(b) shows the relationship between the load changed on the basis of a prediction result and a time until reaching the predetermined crack shape. In FIG. 13(a) and FIG. 13(b), the vertical axis of graphs indicates the load, and the horizontal axis indicates a time until reaching the predetermined crack shape. In the graphs, contour lines 114 and 117 indicate probability distributions. A crack grows as load application or displacement is repeated. The number of repetitions per unit time is actually measured or assumed, whereby a time and the number of repetitions can be converted to each other.

In FIG. 13(a), the contour line 114 is obtained from a probability distribution 111 of a load estimated by the estimation unit 5 and a probability distribution 112 of a time until reaching the predetermined crack shape. From the relationship between the probability distribution 112 of the time until reaching the predetermined crack shape and a time point 113 at which repair is performed, whether the predicted crack will reach a crack shape having a predetermined size until repair is performed can be recognized as a probability including a dispersion.

In a case of using the structure 29 which is a measurement target until repair is performed, a method of changing (reducing) the load may be used. In order to use the structure 29 with predetermined reliability until the time point 113 at which repair is performed, as shown in FIG. 13(b), a changed load distribution 115 and a probability distribution 116 of a time after load change obtained from a probability distribution of a time until reaching the predetermined crack shape, which is estimated from the crack shape and the parameters calculated in step S4, are calculated. The reliability can be calculated from the relationship between the probability distribution 116 of the time and the time point 113 at which repair is performed. In addition, the contour line (new probability distribution) 117 is obtained.

On the basis of the obtained new probability distribution 117, for example, a mean value is outputted, whereby a load or displacement corresponding to such an operation condition that allows the structure 29 to operate until a timing when replacement or repair can be performed, can be calculated and outputted to a target machine structure. Further, a control device for controlling the structure 29 may be provided, and a step of providing a control signal for controlling the structure 29 on the basis of the obtained output may be added after step S6 in the prediction flowchart in FIG. 12.

As described above, with the uncertainty of the growth amount of a crack quantitatively indicated by a probability distribution, such an operation condition that allows a structure to operate until a timing when replacement or repair can be performed can be outputted together with reliability, whereby maintenance can be adjusted until an appropriate timing.

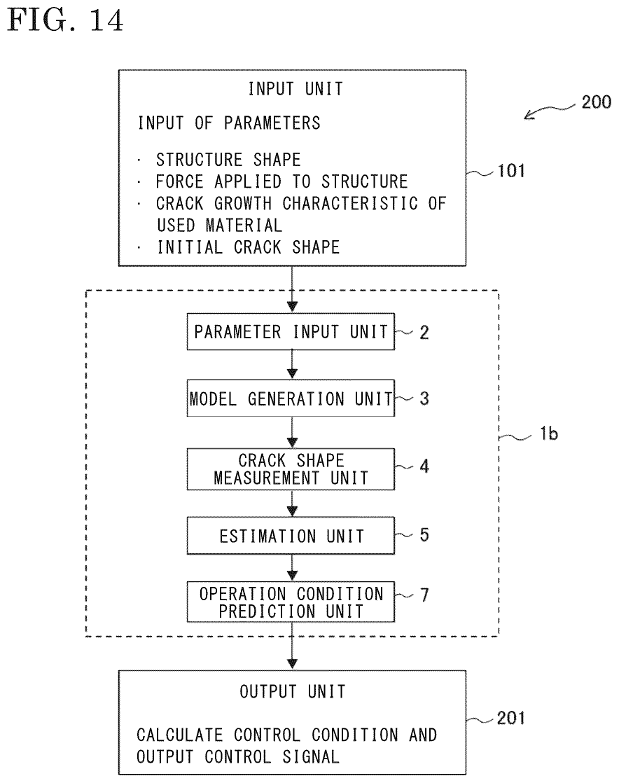

FIG. 14 is a flowchart showing operation of a crack inspection system 200 including the crack growth prediction device 1b described in embodiment 3. In the crack inspection system 200, the shape of the structure 29, a force or displacement applied to the structure 29, the crack growth characteristic of a used material, an initial crack shape, and the like, are inputted as parameters, by an input unit 101. Examples of input means include direct input of data by a keyboard or a mouse, input of data transferred from a memory device, reception of data transmitted wirelessly or via a wire from another device, and reception of data transmitted from the Internet, a cloud, or the like, but the input means is not limited thereto.

With the parameters inputted, the crack growth prediction device 1b performs operation as described above, i.e., the parameter input unit 2 calculates a probability distribution of each parameter, and the model generation unit 3 generates the state space model 42 for predicting the growth state of a crack. In addition, the crack shape measurement unit 4 measures the crack shape, and the estimation unit 5 updates the measured crack shape by the crack shape predicted using the state space model 42, thus estimating the crack shape and the parameters. The operation condition prediction unit 7 calculates the relationship between a probability distribution of a growth time until the crack shape estimated by the estimation unit 5 reaches a predetermined crack shape and a probability distribution of a force applied to the structure among the estimated parameters, to calculate a machine structure control condition for providing such a force that allows the structure to operate until a timing when maintenance can be performed after measurement. An output unit 201 outputs maintenance-related information such as reliability and a probability distribution about the control condition or a control signal corresponding to the control condition. In addition, the output unit 201 may include a display unit, and may display a probability distribution and reliability as shown in FIG. 13(a) and FIG. 13(b). Further, the output unit may include communication means, and may transmit data based on the control condition to another device wirelessly or via a wire. Further, through connection to a network, the above data may be accumulated in a cloud or the like, to collect data about control conditions for many components. Thus, the collected data may be utilized for not only maintenance but also production, sale, and the like of a control device for maintenance. In addition, both of the crack shape prediction unit 6 described in embodiment 2 and the operation condition prediction unit 7 may be included. In this case, one output unit may have both functions of the output unit 102 and the output unit 201, or the crack shape prediction unit 6 and the operation condition prediction unit 7 may have individual output units having the functions of the output unit 102 and the output unit 201.

A specific example regarding a component of a rotor of an electric generator will be described. A preferable example for calculating reliability and the value of such a load that allows operation to be performed until a predetermined maintenance time, is relevant to a temperature change in a rotor due to an output change of an electric generator. There is a possibility that a crack grows with thermal stress due to change in the temperature of the rotor during operation of the electric generator and a stopped state thereof. By performing control of reducing the output of the electric generator using the above-described method, it is possible to allow operation to be performed until a predetermined maintenance time while keeping the temperature of the rotor below a certain value.

A change in an electric generator output and a temperature change in a rotor component differ among electric generators, and uncertainty is included in the temperature change in the rotor component with respect to control for the output change. The output unit 201 determines an output change to be outputted to a control device, considering a temperature of a rotor component and reliability thereof outputted by the operation condition prediction unit 7 described above and uncertainty of the temperature change of the rotor component with respect to control for the output change. Thus, it is possible to control a rotor component so as to reach the temperature outputted by the operation condition prediction unit 7. Here, an example about a temperature has been described, but the same control can be performed also for a structure whose output is changed depending on an applied force. The specifications of the electric generator, information about another electric generator of the same type, or the like may be acquired from the input unit 101.

### Embodiment 4

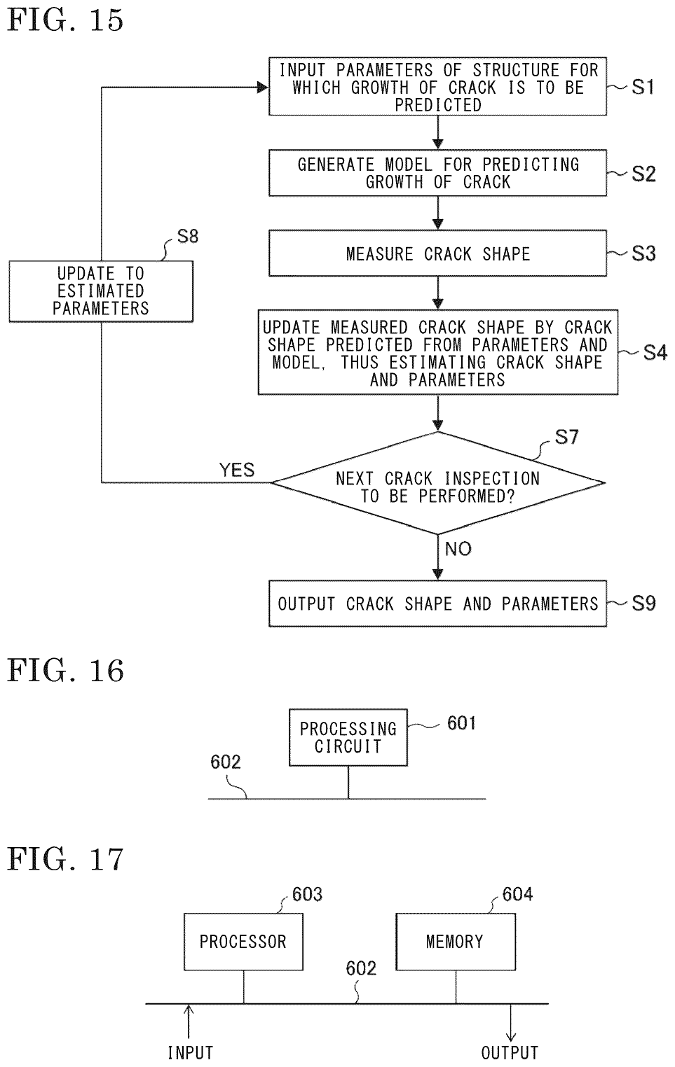

FIG. 15 shows a prediction flowchart in the crack growth prediction device 1 according to the present embodiment of the present disclosure. Only differences from embodiment 1 will be described, while the other matters are the same as in embodiment 1 and the description thereof is omitted. In FIG. 15, whether or not a next crack inspection needs to be performed is determined (step S7), and if the inspection is needed, the parameters estimated in step S4 are used as parameters to be inputted in step S1 (step S8). If the inspection is not needed, the crack shape and the parameters are outputted (step S9).

In this way, the crack shape is repeatedly measured to update the parameters, whereby uncertainty is reduced and thus uncertainty of the crack length to be estimated can be reduced. Further, on the basis of a crack estimation result with the uncertainty reduced, a repair or replacement timing for the structure can be postponed as far as possible, whereby economical maintenance can be performed.

In each embodiment, a processing circuit for implementing the functions of the crack growth prediction device 1, 1a, 1b is provided. The processing circuit may be dedicated hardware or a CPU (also called a central processing unit, a processing device, a computation device, a microprocessor, a microcomputer, a processor, a digital signal processor (DSP), etc.) that executes a program stored in a memory.

FIG. 16 illustrates an example of a hardware configuration of the crack growth prediction device 1, 1a, 1b. In FIG. 16, a processing circuit 601 is connected to a bus 602. In a case where the processing circuit 601 is dedicated hardware, the processing circuit 601 is, for example, a single circuit, a complex circuit, a programmed processor, an application specific integrated circuit (ASIC), a field programmable gate array (FPGA), or a combination thereof. Each of the functions of the crack growth prediction device 1, 1a, 1b may be implemented by the processing circuit 601, or the functions may be collectively implemented by the processing circuit 601.

FIG. 17 illustrates another example of a hardware configuration of the crack growth prediction device 1, 1a, 1b. In FIG. 17, a processor 603 and a memory 604 are connected to a bus 602. In a case where the processor is a CPU, each of the functions of the crack growth prediction device 1, 1a, 1b is implemented by software, firmware, or a combination of software and firmware. The software or firmware is described as a program, which is stored in the memory 604. The processing circuit reads and executes the program stored in the memory 604, to implement the function of each unit. Here, the memory 604 is, for example, a nonvolatile or volatile semiconductor memory such as a random access memory (RAM), a read only memory (ROM), a flash memory, an erasable programmable read only memory (EPROM), or an electrically erasable programmable read only memory (EEPROM), or a magnetic disk, a flexible disk, an optical disc, a compact disc, a mini disc, a digital versatile disc (DVD), etc.

Some of the functions of the crack growth prediction device 1, 1a, 1b may be implemented by dedicated hardware and others may be implemented by software or firmware. For example, the processing circuit as dedicated hardware may implement the model generation unit 3 among the above functions, and may read a program stored in the memory 604 to operate the processor 603 so as to implement the estimation unit 5.

Formula (4) and Formula (5) in FIG. 5, described in embodiment 1, may be obtained through numerical analysis. The stress intensity factor range to be used in predicting growth of a crack may be formulated through an experiment or theoretically. However, there are some crack shapes that have not been formulated, in actual structures. If the stress intensity factor range for a crack shape that has not been formulated is obtained through numerical analysis, it is not necessary to perform formulation through an experiment or theoretically, and thus a time required for preparation for using the prediction device is shortened.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure.

For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1, 1a, 1b crack growth prediction device
2 parameter input unit
3 model generation unit
4 crack shape measurement unit
5 estimation unit
6 crack shape prediction unit
7 operation condition prediction unit

1. A crack growth prediction device for predicting growth of a crack occurring in a structure, the crack growth prediction device comprising:
a parameter input circuitry to which parameters of initial values of at least a shape of the structure, a force applied to the structure, a material characteristic of the structure, and a crack shape, including uncertainty of each parameter, are each inputted as a probability distribution;
a model generation circuitry which generates a state space model for predicting a crack growth state constituted of a state equation and an observation equation from the inputted parameters;
a crack shape measurement circuitry which measures the crack shape of the structure; and
an estimation circuitry which estimates a posterior distribution including the crack shape and the parameters, from a likelihood distribution of a measurement value of the crack shape measured by the crack shape measurement circuitry and uncertainty due to measurement error, and a prior distribution of the crack shape predicted by the state space model.

2. The crack growth prediction device according to claim 1, wherein
a temperature change is added as the parameter.

3. The crack growth prediction device according to claim 1, wherein
the material characteristic of the structure is a crack growth characteristic.

4. The crack growth prediction device according to claim 1, further comprising a crack shape prediction circuitry which predicts a probability distribution of the crack shape at any time after measurement by the crack shape measurement circuitry, from the crack shape estimated by the estimation circuitry.

5. The crack growth prediction device according to claim 1, further comprising an operation condition prediction circuitry which calculates a probability distribution of a time until the crack shape reaches a predetermined shape, from the posterior distribution estimated by the estimation circuitry.

6. The crack growth prediction device according to claim 2, further comprising an operation condition prediction circuitry which calculates a relationship between a probability distribution of a time until the crack shape reaches a predetermined shape and a temperature or the force applied to the structure, from the posterior distribution estimated by the estimation circuitry, and thereby calculates such a control condition for the temperature or the force that allows the structure to operate until a predetermined crack repair time point after a measurement time point.

7. The crack growth prediction device according to claim 6, further comprising a control device which controls the structure on the basis of the control condition calculated by the operation condition prediction circuitry.

8. The crack growth prediction device according to claim 6, wherein
the operation condition prediction circuitry calculates reliability from a relationship between the repair time point and the probability distribution of the time until the crack shape reaches the predetermined shape under the temperature or the force changed in accordance with the control condition.

9. The crack growth prediction device according to claim 8, further comprising a control device which controls the structure on the basis of the control condition and the reliability calculated by the operation condition prediction circuitry.

10. The crack growth prediction device according to claim 1, wherein
every time the crack shape measurement circuitry measures the crack shape, the parameters updated by the estimation circuitry are inputted to the parameter input circuitry.

11. The crack growth prediction device according to claim 1, wherein
an ensemble Kalman filter is used for the estimation circuitry.

12. The crack growth prediction device according to claim 1, wherein
ultrasonic flaw detection is used for the crack shape measurement circuitry.

13. A crack inspection system comprising:
a crack growth prediction device including
a parameter input circuitry to which parameters of initial values of at least a shape of a structure, a force applied to the structure, a material characteristic of the structure, and a crack shape, including uncertainty of each parameter, are each inputted as a probability distribution,
a model generation circuitry which generates a state space model for predicting a crack growth state constituted of a state equation and an observation equation from the inputted parameters,
a crack shape measurement circuitry which measures the crack shape of the structure,
an estimation circuitry which estimates a posterior distribution including the crack shape and the parameters, from a likelihood distribution of a measurement value of the crack shape measured by the crack shape measurement circuitry and uncertainty due to measurement error, and a prior distribution of the crack shape predicted by the state space model, and
a crack shape prediction circuitry which predicts a probability distribution of the crack shape at any time after measurement by the crack shape measurement circuitry, from the crack shape estimated by the estimation circuitry;
an input for inputting the parameters to the crack growth prediction device; and
an output which outputs maintenance-related information including at least information about a next inspection timing, on the basis of an output of the crack growth prediction device.

14. The crack inspection system according to claim 13, further comprising an operation condition prediction circuitry which calculates a relationship between a probability distribution of a time until the crack shape reaches a predetermined shape and the force applied to the structure, from the posterior distribution estimated by the estimation circuitry, and thereby calculates such a control condition for the force that allows the structure to operate until a predetermined crack repair time point after a measurement time point, wherein
on the basis of an output about the control condition from the operation condition prediction circuitry, the output or a different output outputs maintenance-related information or a control signal corresponding to the control condition.

15. The crack inspection system according to claim 13, further comprising an operation condition prediction circuitry which, with a temperature added as the parameter, outputs such a temperature or a force that allows the structure to operate until a timing when maintenance can be performed after measurement, together with reliability; on the basis of the parameters and the crack shape of the structure obtained by the estimation circuitry, wherein
a control signal, the reliability, and an operation condition outputted from the operation condition prediction circuitry are inputted, and on the basis of uncertainty of control calculated from a difference between an actual operation state of the structure and an instruction by the control signal, a signal for controlling the structure so as to reach the temperature or the force outputted by the operation condition prediction circuitry is outputted from the output or a different output.

16. A crack growth prediction method for predicting growth of a crack occurring in a structure, the crack growth prediction method comprising the steps of:
inputting parameters of initial values of at least a shape of the structure, a force applied to the structure, a material characteristic of the structure, and a crack shape, including uncertainty of each parameter, as a probability distribution;
generating a state space model for predicting a crack growth state constituted of a state equation and an observation equation from the inputted parameters;
measuring the crack shape of the structure; and
estimating a posterior distribution including the crack shape and the parameters, from a probability distribution of a measurement value of the crack shape measured in the crack shape measurement and uncertainty due to measurement error, and a prior distribution of the crack shape predicted by the state space model, wherein
growth of the crack is predicted from the crack shape and the parameters updated by the estimation.
